(19) United States
(12) Patent Application Publication
(10) Pub. No.: US 2008/0036913 A1
(43) Pub. Date: Feb. 14, 2008

(54) ELECTRONIC DEVICE

(75) Inventors: Shih-Ping Yeh, Taipei (TW); Tsung-Po Lin, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ASUSTEK COMPUTER INC., Taipei (TW)

(21) Appl. No.: 11/836,143

(22) Filed: Aug. 9, 2007

(30) Foreign Application Priority Data
Aug. 11, 2006 (TW) 95129501

(51) Int. Cl. H04N 5/44

(52) U.S. Cl. 348/553; 348/E05.096

(57) ABSTRACT

An electronic device includes a host and an image-catching device, wherein the image-catching device is disposed at the host. The above-mentioned image-catching device is able to provide an image signal and wirelessly transfer the image signal to the host.

### CROSS-REFERENCE TO RELATED APPLICATION

This application claims the priority benefit of Taiwan application serial no. 95129501, filed Aug. 11, 2006. All disclosure of the Taiwan application is incorporated herein by reference.

### BACKGROUND OF THE INVENTION

1. Field of the Invention

The present invention generally relates to an electronic device, and more particular, to an electronic device having an image-catching module.

2. Description of Related Art

An electronic device, for example, a notebook computer, usually has an image-catching module for the user to interact with a remote user, or to record the audio and video (AV) of a user. In addition to a dynamic photographing function, the image-catching device has a still photographing function as well.

FIG. 1 is a diagram of a conventional electronic device externally connected to an image-catching module. It can be seen that the electronic device 100 in FIG. 1 is externally connected to an image-catching module 110 to perform the image-catching function. Wherein, the image-catching module 110 is electrically connected to the electronic device 100 through an image-transferring cable 112 for image transmission. Besides, the image-catching module 110 is movably mounted over the display screen 102 for catching images. It should be noted that the image-catching module 110 is electrically connected to the electronic device 100 through the image-transferring cable 112 for transferring image signals; thus, for a user to catch images by using the image-catching module 110, the user may not be able to catch the image of a target located relatively far from the electronic device 100 by using the image-catching module 110 as he/she is restricted by the limited length of the image-transferring cable 112. To clearly catch the images of such a target, the user needs to move the electronic device 100 to a place close to the target to be photographed with some efforts. However, such a solution by moving the electronic device 100 for the image-catching module 110 to clearly catch the images would cause inconveniences with the user.

### SUMMARY OF THE INVENTION

An objective of the present invention is to provide an electronic device for overcoming the problem that the image-catching device mounted on the electronic device is incapable of photographing the images of a target located relatively far from the electronic device.

To achieve the above-described or other objectives, the present invention provides an electronic device, which includes a host and an image-catching device, wherein the image-catching device is disposed at the host. The above-described image-catching device is able to provide an image signal and wirelessly transfer the image signal to the host.

In an embodiment of the present invention, the above-described electronic device further includes a signal-transferring module and a signal-receiving module, wherein the signal-receiving module is disposed at the host, the signal-transferring module is disposed at the image-catching device and the image signal is wirelessly transferred to the signal-receiving module through the signal-transferring module.

In an embodiment of the present invention, the above-described signal-transferring module is a Bluetooth module, and the signal-transferring module is able to transfer signals through a radio wave and the signal-receiving module.

In an embodiment of the present invention, the above-described image-catching device includes a base and an image-catching module, the base is moveably disposed at the host, the image-catching module is pivoted at the base and the image-catching module and the signal-transferring module are electrically connected to each other.

In an embodiment of the present invention, the above-described image-catching device further includes a pivot axle, and the image-catching module is pivoted at the base through the pivot axle.

In an embodiment of the present invention, the above-described image-catching device further includes a rechargeable battery, which is electrically connected to the image-catching module.

In an embodiment of the present invention, the above-described image-catching module includes a lens, an image sensor and a case, wherein the lens is disposed at and through the case, while the image sensor is electrically connected to the signal-transferring module.

In an embodiment of the present invention, the above-described image-catching module further includes an adjustment knob, which is electrically connected to the lens and the image sensor.

In an embodiment of the present invention, the above-described image sensor is a complementary metal oxide semiconductor device (CMOS device).

In an embodiment of the present invention, the above-described host has a containing portion and the base is disposed at the containing portion.

In an embodiment of the present invention, the above-described containing portion has a first connection portion, the base has a second connection portion and the base is disposed at the containing portion by interconnecting the first connection portion and the second connection portion.

In the electronic device of the present invention, since the image-catching device has the wireless signal-transferring function and the image-catching device is moveably disposed on the host, therefore, the image-catching device can be taken off from the host by a user for catching the desired images and further wirelessly transferring the image signal to the host through the signal-transferring module for the user to browse the caught images. As a result, the user can freely use the image-catching device to catch a scene located relatively far from the electronic device without worrying the restriction of the limited length of the image-transferring cable.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a conventional electronic device externally connected to an image-catching module.

FIG. 2 is a diagram of an electronic device of an embodiment of the present invention.

FIG. 3 is a schematic exploded drawing of the base in FIG. 2.

FIG. 4 is a schematic exploded drawing of the image-catching module in FIG. 2.

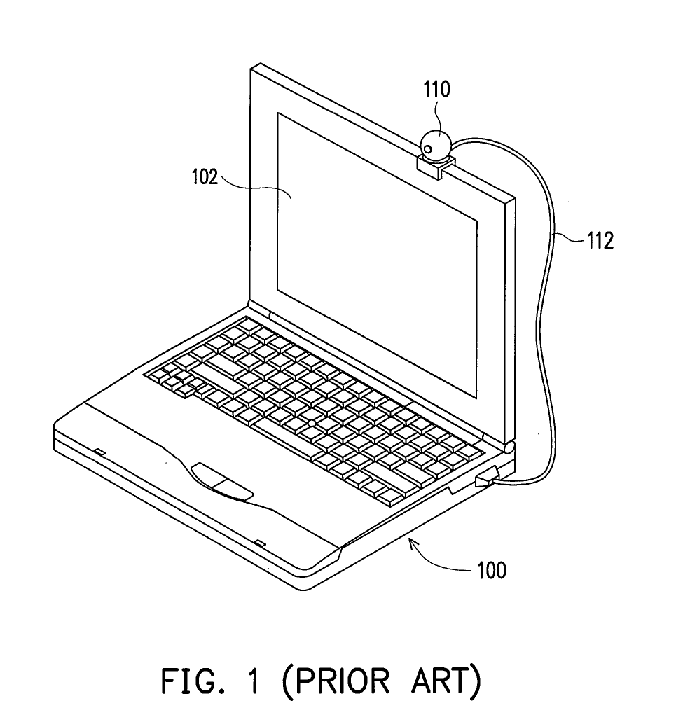

### DESCRIPTION OF THE EMBODIMENTS

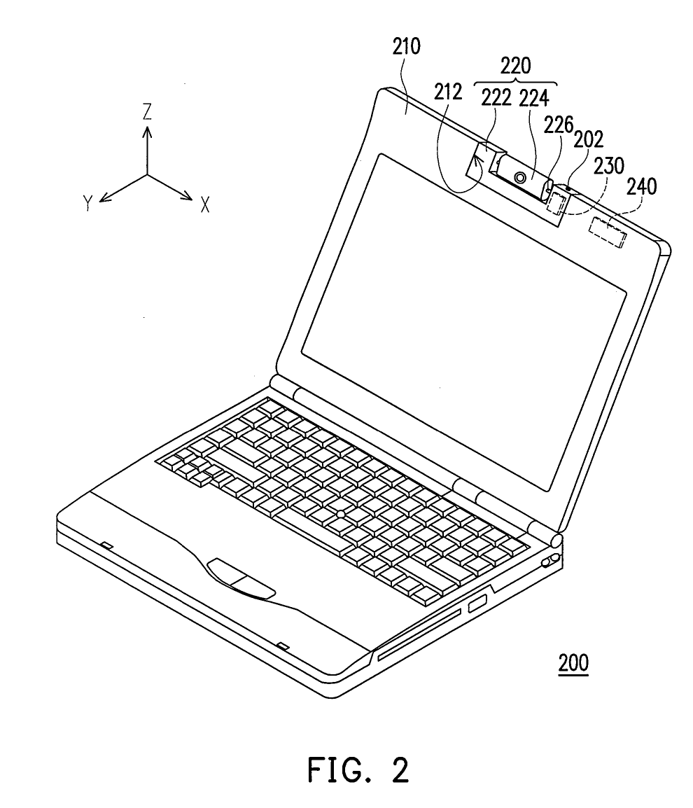

FIG. 2 is a diagram of an electronic device of an embodiment of the present invention. Referring to FIG. 2, the electronic device 200 of the present embodiment is, for example, a notebook computer, which includes a host 210 and an image-catching device 220, wherein the image-catching device 220 is disposed at the host 210. The image-catching device 220 of the embodiment is suitable for providing an image signal and is able to wirelessly transfer the image signal to the host 210. In the embodiment, the image-catching device 220 is disposed, for example, in a containing portion 212 of the host 210, so that the overall appearance of the electronic device 200 is not affected by the disposition of the image-catching device 220.

In addition, the image-catching device 200 of the embodiment, for example, has a signal-receiving module 240 disposed in the host 210 and a signal-transferring module 230 disposed in the image-catching device 220, and the image signal is wirelessly transferred to the signal-receiving module 240 through the signal-transferring module 230. In this way, when the user takes off the image-catching device 220 from the host 210 and presses down a shutter-release button 202 for catching an image, the image signal is transferred in wireless transmission way to the signal-receiving module 240 on the host 210 through the signal-transferring module 230. After the internal system of the host 210 processes the image signal received by the signal-receiving module 240, the user or a remote user is able to browse the photographed images. Wherein, the above-described signal-transferring module 230 is, for example, a Bluetooth module, while the signal-transferring module 230 uses, for example, a radio wave to deliver a signal to the signal-receiving module 240.

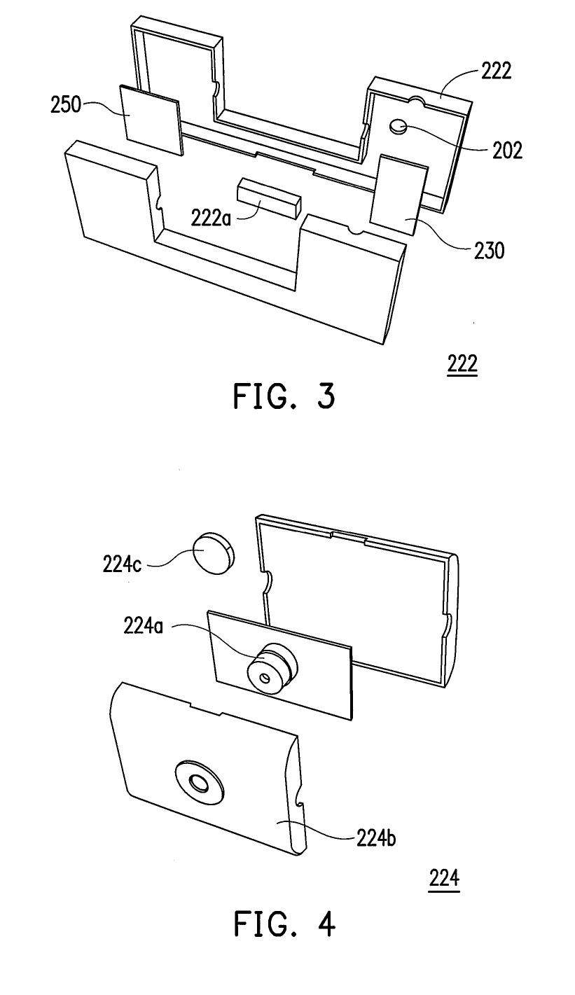

Furthermore, the image-catching device 220 of the embodiment comprises, for example, a base 222 and an image-catching module 224 electrically connected to the signal-transferring module 230. Wherein, the image-catching module 224 is pivoted at the base 222 through a pivot axle 226, while the signal-transferring module 230 is disposed, for example, in the base 222. In the embodiment, since the image-catching module 224 is pivoted at the base 222 through the pivot axle 226, the image-catching module 224 is able to rotate around the axis of the pivot axle 226 for catching images from different angles of view (AOVs). Besides, the base 222 of the embodiment is moveably disposed at the containing portion 212 of the host 210. For example, the containing portion 212 has a first connection portion (not shown) and the base 222 has a second connection portion 222a corresponding to the first connection portion (referring to FIG. 3, where the schematic exploded drawing of the base in FIG. 2 is shown), thus, the base 222 is disposed at the containing portion 212 by interconnecting the first connection portion and the second connection portion 222a. Certainly, the present invention does not limit the disposition manner of the base 222 at the host 210. In other embodiments, the base 222 can be disposed on the host 210 by using appropriate snap elements.

In addition to disposing the second connection portion 222a and the signal-transferring module 230 in the base 222, a rechargeable battery 250 electrically connected to the image-catching module 224 can be disposed in the base. Hence, when the image-catching device 220 is taken off from the host 210 for taking images, the rechargeable battery 250 can supply the electrical energy required for the operations to the image-catching module 224. On the other hand, when the image-catching device 220 is placed back at the containing portion 212 and the first connection portion of the base 222 is interconnected to the second connection portion 222a of the image-catching device 220, the host is able to charge the rechargeable battery 250 in the image-catching device 220.

FIG. 4 is a schematic exploded drawing of the image-catching module in FIG. 2. Referring to FIG. 4, the image-catching module 224 of the embodiment mainly includes a lens 224a, an image sensor (not shown) and a case 224b. Wherein, the lens 224a is disposed at and through the case 224b, and the image sensor is located, for example, on the optical path behind the lens 224a and is electrically connected to the signal-transferring module 230 (referring to FIG. 3). In the embodiment, the image sensor is, for example, a CMOS device. In other embodiments, however, the image sensor can be a charge coupled device (CCD) or other appropriate optical elements as well. In addition, the image-catching module 224 can include an adjustment knob 224c electrically connected to the lens 224a and the image sensor. By turning the adjustment knob 224c, the user is able to vary the focal length of the lens 224a for clearly catching images. In a preferred embodiment, the user can adjust the focal length of the lens 224a by manipulating the host 210 (referring to FIG. 2) and coordinating the signal-transferring module 230 and the signal-receiving module 240 at the same time.

In summary, the present invention utilizes and disposes a wireless signal transmission module in the image-catching device to wirelessly transfer the images caught by the image-catching device to the host. Therefore, the image-catching device of the present invention would be free from the length restriction of the image-transferring cable for catching images. In other words, the user can take off the image-catching device from the host to photograph a scene located relatively far from the electronic device without concerning about the restriction of the limited length of the image-transferring cable.

It will be apparent to those skilled in the art that various modifications and variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

What is claimed is:

1. An electronic device, comprising:
a host; and
an image-catching device, disposed at the host for providing an image signal and wirelessly transferring the image signal to the host.

2. The electronic device according to claim 1, further comprising a signal-transferring module and a signal-receiving module, wherein the signal-receiving module is disposed at the host, the signal-transferring module is disposed at the image-catching device and the image signal is wirelessly transferred to the signal-receiving module through the signal-transferring module.

3. The electronic device according to claim 2, wherein the signal-transferring module is a Bluetooth module and delivers signals to the signal-receiving module by using a radio wave.

4. The electronic device according to claim 2, wherein the image-catching device comprises a base and an image-catching module, the base is moveably disposed at the host, the image-catching module is pivoted at the base, and the image-catching module and the signal-transferring module are electrically connected to each other.

5. The electronic device according to claim 4, wherein the image-catching device further comprises a pivot axle, while the image-catching module is pivoted at the base through the pivot axle.

6. The electronic device according to claim 4, wherein the image-catching device further comprises a rechargeable battery disposed in the base, and the rechargeable battery and the image-catching module are electrically connected to each other.

7. The electronic device according to claim 4, wherein the image-catching module comprises a lens, an image sensor and a case, wherein the lens is disposed at and through the case, while the image sensor and the signal-transferring module are electrically connected to each other.

8. The electronic device according to claim 7, wherein the image-catching module further comprises an adjustment knob, and the adjustment knob is electrically connected to the lens and the image sensor.

9. The electronic device according to claim 7, wherein the image sensor is a complementary metal oxide semiconductor device (CMOS device).

10. The electronic device according to claim 4, wherein the host has a containing portion and the base is disposed at the containing portion.

11. The electronic device according to claim 10, wherein the containing portion has a first connection portion, the base has a second connection portion, and the base is disposed at the containing portion by interconnecting the first connection portion and the second connection portion.
